(19) United States
(12) Patent Application Publication
(10) Pub. No.: US 2026/0004323 A1
(43) Pub. Date: Jan. 1, 2026

(54) CONTENT PRESENTATION USING AN EXPLOITATION-EXPLORATION PARADIGM

(71) Applicant: Roku, Inc., San Jose, CA (US)

(72) Inventors: Atishay JAIN, San Bruno, CA (US); Pulkit Aggarwal, San Jose, CA (US); Abhishek Bambha, Burlingame, CA (US); Ronica Jethwa, Mountain View, CA (US); Lian Liu, San Jose, CA (US); Rohit Mahto, San Jose, CA (US); Jose Sanchez, San Jose, CA (US); Nam Vo, San Jose, CA (US); Fei Xiao, San Jose, CA (US)

(73) Assignee: Roku, Inc., San Jose, CA (US)

(21) Appl. No.: 18/760,881

(22) Filed: Jul. 1, 2024

(51) Int. Cl. G06Q 30/0251

(52) U.S. Cl. CPC G06Q 30/0255

(57) ABSTRACT

Disclosed herein are system, apparatus, article of manufacture, method and/or computer program product embodiments, and/or combinations and sub-combinations thereof, for providing content to a user so as to balance known content of interest to the user, and potential new content of interest (e.g., exploration content). An example embodiment operates by receiving and analyzing behavioral data of a user as it relates to exploration content. This behavioral data may include the user selecting, slowing scrolling, pausing scrolling, or other actions that indicate interest in provided exploration content. Based on this data, the user's proclivity for exploration content is determined. This proclivity is compared to a current exploration value associated with the user, and used in one of a variety of different ways to calculate an adjustment to the user's exploration content value, which dictates an amount of exploration content that will be provided to the user.

### BACKGROUND

### Field

This disclosure is generally directed to content presentation, and more particularly to optimizing and customizing content output to a user.

### SUMMARY

Provided herein are system, apparatus, article of manufacture, method and/or computer program product embodiments, and/or combinations and sub-combinations thereof, for providing content to a user so as to balance known content of interest to the user, and potential new content of interest.

An example embodiment operates by receiving and analyzing behavioral data of the user relative to exploration content. Based on this analysis, the user's proclivity for exploration content can be determined, with a high proclivity demonstrating a user likely to express interest in and/or consume exploration content. This proclivity is then compared to the user's current exploration value-a value that dictates an amount of exploration content provided to the user. Based on this comparison, an adjusted exploration value is calculated, which is then used to improve future content browsing sessions for the user.

In an example embodiment, the behavioral data may include selections, clicks, pauses, slowed scrolling, etc. with respect to exploration content.

In an example embodiment, the proclivity is determined based on a frequency with which the user interacts with, or otherwise expresses interest in, exploration content.

In example embodiments, the adjustment to the current exploration value may be determined in one of several different ways. In a first method, the proclivity is converted, based on where the user's proclivity falls within an acceptable range, to a corresponding suggested exploration value based on an acceptable range of exploration value.

In another embodiment, the adjustment to the current exploration value can be calculated based on a comparison of the user's proclivity to a baseline value. A large difference between the user's proclivity and the baseline value may translate to a large increase or decrease to the user's exploration value, whereas a small difference may translate to little or no change to the user's exploration value.

In another embodiment, a machine-learning AI model can receive the user's behavioral data, historical adjustment and/or exploration value data, and other inputs, and calculate the updated exploration value.

These and other aspects of the present disclosure will be described in further detail below with respect to the relevant figures.

### BRIEF DESCRIPTION OF THE FIGURES

The accompanying drawings are incorporated herein and form a part of the specification.

FIG. 1 illustrates a block diagram of a multimedia environment, according to some embodiments.

FIG. 2 illustrates a block diagram of a streaming media device, according to some embodiments.

FIG. 3 illustrates a block diagram of an exemplary content exploration management system.

FIG. 4 illustrates a block diagram of an exemplary exploration calculator according to embodiments of the present disclosure.

FIG. 5 illustrates a flowchart diagram of an exemplary method for exploration value adjustment, according to embodiments of the present disclosure.

FIG. 6 illustrates an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for optimizing content providing to a user. Specifically, in many content providing systems, such as lists of articles, audio clips, videos, etc., a machine learning model operates in the background to select the specific content items provided to the user. In most cases, this model provides the user with content that is similar to, or related to, content previous consumed by the user, or of which the user has shown some interest. However, only providing the user with content known to be of interest can result in the user being trapped in what is referred to as a filter bubble. In this filter bubble, the user is only ever provided with the same content, and they never or rarely are given opportunities to venture outside of this bubble and explore new content.

The present disclosure described embodiments for optimizing and customizing a ratio with which a user is provided new content to explore. In embodiments, the system customizes the exploration opportunities for a user based on their use history and their proclivity for selected exploration content over known content. These and other aspects will be described in further detail below.

It should also be understood that, while aspects of the disclosure are described in terms of an exploration content system, the concepts described herein may be generally applicable to other areas. For example, inventive aspects described herein may be used to balance content with different objectives, such as content with a probability of generating high engagement, as well as content with a probability of generating high revenue, to provide some examples.

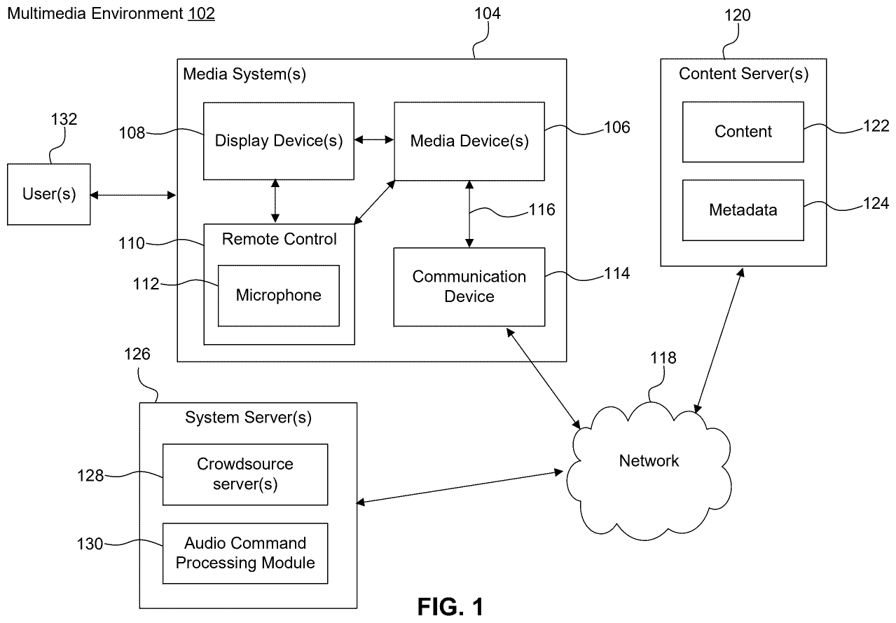

Various embodiments of this disclosure may be implemented using and/or may be part of a multimedia environment 102 shown in FIG. 1. It is noted, however, that multimedia environment 102 is provided solely for illustrative purposes, and is not limiting. Embodiments of this disclosure may be implemented using and/or may be part of environments different from and/or in addition to the multimedia environment 102, as will be appreciated by persons skilled in the relevant art(s) based on the teachings contained herein. An example of the multimedia environment 102 shall now be described.

### Multimedia Environment

FIG. 1 illustrates a block diagram of a multimedia environment 102, according to some embodiments. In a non-limiting example, multimedia environment 102 may be directed to streaming media. However, this disclosure is applicable to any type of media (instead of or in addition to streaming media), as well as any mechanism, means, protocol, method and/or process for distributing media.

The multimedia environment 102 may include one or more media systems 104. A media system 104 could represent a family room, a kitchen, a backyard, a home theater, a school classroom, a library, a car, a boat, a bus, a plane, a movie theater, a stadium, an auditorium, a park, a bar, a restaurant, or any other location or space where it is desired to receive and play streaming content. User(s) 132 may operate with the media system 104 to select and consume content.

Each media system 104 may include one or more media devices 106 each coupled to one or more display devices 108. It is noted that terms such as “coupled,” “connected to,” “attached,” “linked,” “combined” and similar terms may refer to physical, electrical, magnetic, logical, etc., connections, unless otherwise specified herein.

Media device 106 may be a streaming media device, DVD or BLU-RAY device, audio/video playback device, cable box, and/or digital video recording device, to name just a few examples. Display device 108 may be a monitor, television (TV), computer, smart phone, tablet, wearable (such as a watch or glasses), appliance, internet of things (IoT) device, and/or projector, to name just a few examples. In some embodiments, media device 106 can be a part of, integrated with, operatively coupled to, and/or connected to its respective display device 108.

Each media device 106 may be configured to communicate with network 118 via a communication device 114. The communication device 114 may include, for example, a cable modem or satellite TV transceiver. The media device 106 may communicate with the communication device 114 over a link 116, wherein the link 116 may include wireless (such as WiFi) and/or wired connections.

In various embodiments, the network 118 can include, without limitation, wired and/or wireless intranet, extranet, Internet, cellular, Bluetooth, infrared, and/or any other short range, long range, local, regional, global communications mechanism, means, approach, protocol and/or network, as well as any combination(s) thereof.

Media system 104 may include a remote control 110. The remote control 110 can be any component, part, apparatus and/or method for controlling the media device 106 and/or display device 108, such as a remote control, a tablet, laptop computer, smartphone, wearable, on-screen controls, integrated control buttons, audio controls, or any combination thereof, to name just a few examples. In an embodiment, the remote control 110 wirelessly communicates with the media device 106 and/or display device 108 using cellular, Bluetooth, infrared, etc., or any combination thereof. The remote control 110 may include a microphone 112, which is further described below.

The multimedia environment 102 may include a plurality of content servers 120 (also called content providers, channels or sources 120). Although only one content server 120 is shown in FIG. 1, in practice the multimedia environment 102 may include any number of content servers 120. Each content server 120 may be configured to communicate with network 118.

Each content server 120 may store content 122 and metadata 124. Content 122 may include any combination of music, videos, movies, TV programs, multimedia, images, still pictures, text, graphics, gaming applications, advertisements, programming content, public service content, government content, local community content, software, and/or any other content or data objects in electronic form.

In some embodiments, metadata 124 comprises data about content 122. For example, metadata 124 may include associated or ancillary information indicating or related to writer, director, producer, composer, artist, actor, summary, chapters, production, history, year, trailers, alternate versions, related content, applications, and/or any other information pertaining or relating to the content 122. Metadata 124 may also or alternatively include links to any such information pertaining or relating to the content 122. Metadata 124 may also or alternatively include one or more indexes of content 122, such as but not limited to a trick mode index.

The multimedia environment 102 may include one or more system servers 126. The system servers 126 may operate to support the media devices 106 from the cloud. It is noted that the structural and functional aspects of the system servers 126 may wholly or partially exist in the same or different ones of the system servers 126.

The media devices 106 may exist in thousands or millions of media systems 104. Accordingly, the media devices 106 may lend themselves to crowdsourcing embodiments and, thus, the system servers 126 may include one or more crowdsource servers 128.

For example, using information received from the media devices 106 in the thousands and millions of media systems 104, the crowdsource server(s) 128 may identify similarities and overlaps between closed captioning requests issued by different users 132 watching a particular movie. Based on such information, the crowdsource server(s) 128 may determine that turning closed captioning on may enhance users' viewing experience at particular portions of the movie (for example, when the soundtrack of the movie is difficult to hear), and turning closed captioning off may enhance users' viewing experience at other portions of the movie (for example, when displaying closed captioning obstructs critical visual aspects of the movie). Accordingly, the crowdsource server(s) 128 may operate to cause closed captioning to be automatically turned on and/or off during future streamings of the movie.

The system servers 126 may also include an audio command processing module 130. As noted above, the remote control 110 may include a microphone 112. The microphone 112 may receive audio data from users 132 (as well as other sources, such as the display device 108). In some embodiments, the media device 106 may be audio responsive, and the audio data may represent verbal commands from the user 132 to control the media device 106 as well as other components in the media system 104, such as the display device 108.

In some embodiments, the audio data received by the microphone 112 in the remote control 110 is transferred to the media device 106, which is then forwarded to the audio command processing module 130 in the system servers 126. The audio command processing module 130 may operate to process and analyze the received audio data to recognize the user 132's verbal command. The audio command processing module 130 may then forward the verbal command back to the media device 106 for processing.

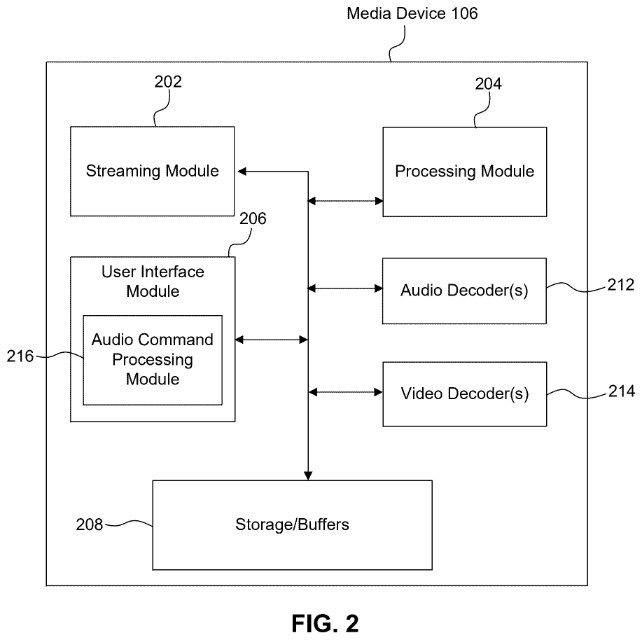

In some embodiments, the audio data may be alternatively or additionally processed and analyzed by an audio command processing module 216 in the media device 106 (see FIG. 2). The media device 106 and the system servers 126 may then cooperate to pick one of the verbal commands to process (either the verbal command recognized by the audio command processing module 130 in the system servers 126, or the verbal command recognized by the audio command processing module 216 in the media device 106).

FIG. 2 illustrates a block diagram of an example media device 106, according to some embodiments. Media device 106 may include a streaming module 202, processing module 204, storage/buffers 208, and user interface module 206. As described above, the user interface module 206 may include the audio command processing module 216.

The media device 106 may also include one or more audio decoders 212 and one or more video decoders 214.

Each audio decoder 212 may be configured to decode audio of one or more audio formats, such as but not limited to AAC, HE-AAC, AC3 (Dolby Digital), EAC3 (Dolby Digital Plus), WMA, WAV, PCM, MP3, OGG GSM, FLAC, AU, AIFF, and/or VOX, to name just some examples.

Similarly, each video decoder 214 may be configured to decode video of one or more video formats, such as but not limited to MP4 (mp4, m4a, m4v, f4v, f4a, m4b, m4r, f4b, mov), 3GP (3gp, 3gp2, 3g2, 3gpp, 3gpp2), OGG (ogg, oga, ogv, ogx), WMV (wmv, wma, asf), WEBM, FLV, AVI, QuickTime, HDV, MXF (OP1a, OP-Atom), MPEG-TS, MPEG-2 PS, MPEG-2 TS, WAV, Broadcast WAV, LXF, GXF, and/or VOB, to name just some examples. Each video decoder 214 may include one or more video codecs, such as but not limited to H.263, H.264, H.265, AVI, HEV, MPEG1, MPEG2, MPEG-TS, MPEG-4, Theora, 3GP, DV, DVCPRO, DVCPRO, DVCProHD, IMX, XDCAM HD, XDCAM HD422, and/or XDCAM EX, to name just some examples.

Now referring to both FIGS. 1 and 2, in some embodiments, the user 132 may interact with the media device 106 via, for example, the remote control 110. For example, the user 132 may use the remote control 110 to interact with the user interface module 206 of the media device 106 to select content, such as a movie, TV show, music, book, application, game, etc. The streaming module 202 of the media device 106 may request the selected content from the content server(s) 120 over the network 118. The content server(s) 120 may transmit the requested content to the streaming module 202. The media device 106 may transmit the received content to the display device 108 for playback to the user 132.

In streaming embodiments, the streaming module 202 may transmit the content to the display device 108 in real time or near real time as it receives such content from the content server(s) 120. In non-streaming embodiments, the media device 106 may store the content received from content server(s) 120 in storage/buffers 208 for later playback on display device 108.

### Content Exploration System

Referring to FIG. 1, the media devices 106 may exist in thousands or millions of media systems 104. Accordingly, the media devices 106 may lend themselves to crowdsourcing embodiments. In some embodiments, one or more processors in the system 100 perform content exploration management. As will be used herein, exploration content will be understood to refer to any content outside of the user's filter bubble. In other words, content algorithms are generally trained to determine a user's preferences and interests over time. This creates a filter bubble, in which the user is provided content consistent with those known interests. Exploration content refers to content outside of that filter bubble, meant to provide the user with opportunities to demonstrate new or different interests from those already known.

For example, using information received from the media devices 106 in the thousands and millions of media systems 104, the content exploration management system may gather user behavioral data with respect to content browsing, and adjust an amount of exploration content provided to the user in order to optimize the user's content browsing experience. In other words, analyzing the behavioral data of a user will allow the content exploration management system to determine whether to increase the amount of exploration content provided to the user, to decrease the amount of exploration content provided to the user, or to maintain a current amount of exploration content provided to the user. Through the use of this system, a user's desire to explore new content can be efficiently satisfied for optimized browsing experience. Additionally, through the use of this approach, the functioning of the computer is greatly improved, at least because its resources will be used more efficiently. Specifically, by optimizing the user's exploration content, unnecessary computing resources are no longer wasted on providing undesired content to the user.

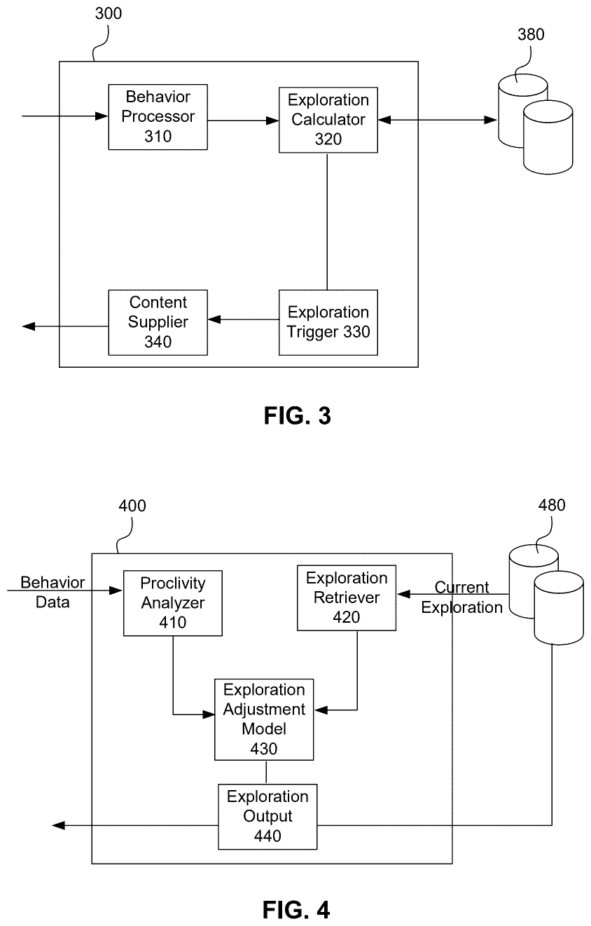

FIG. 3 illustrates a block diagram of an exemplary content exploration management system 300. As shown in FIG. 3, the content exploration management system 300 includes a behavior processing module 310, an exploration calculation 320, an exploration trigger 330, and a content supplier 340.

In some embodiments, a user's browsing activity is monitored while the user is perusing available content. This may occur for any of a variety of different content types, including videos, news articles, images, music, television programs, movies, streaming content, etc. As the user interacts with the content, behavioral data of the user is captured that describes the type of content that the user is consuming. This may include identifying content selected, watched, or listened to, by the user as well as identifying other content for which the user slowed or stopped their scrolling, etc. This behavioral data is provided to the content exploration management system 300 via the behavior processing module processing module 310.

The behavior processing module 310 can receive the user behavioral data, and perform an analysis thereon in order to determine an amount or frequency that the user deviates from known content of interest. As discussed above, most content systems provide exploration content to a user based on a flat percentage. In one example, this results in the user being provided with exploration content 10% of the time. The user's interaction with this exploration content can be tracked as user behavior data. Therefore, the behavior processing module 310 can analyze the user behavior data to determine whether the user frequently interacts with the exploration content, rarely interacts with the exploration content, or otherwise.

For example, the behavior processing module 310 may obtain the user's current exploration content amount from a user database 380. If no historic data exists, then the behavior processing module 310 may analyze the user's behavior relative to a standard or default exploration content amount, such as 10% is the above example. The behavior processing module 310 then makes a determination as to how often the user selects, slows browsing at, or otherwise takes actions to show an interest in exploration content when it is provided. In some embodiments, this may include an analysis of which user behavior instances occur at times of exploration content being provided to the user.

As a result of the behavioral analysis, the behavioral processor 310 may generate an exploration interest value. In some embodiments, the exploration interest value may be indicative of a relative amount that the user expresses interest in exploration content. In some embodiments, this value can be expressed as a percentage or a score value. The behavior processing module 310 provides the exploration interest value to the exploration calculator 320.

The exploration calculator 320 can receive the exploration interest value from the behavior processing module 310, and use the exploration interest value to calculate an updated exploration value. In some embodiments, the exploration calculator 320 obtains the user's current exploration value from the user database 380. The exploration calculator 320, then makes a determination as to whether the user's exploration value needs to be modified based on the exploration interest value.

In some embodiments, the exploration calculator 320 analyzes the received exploration interest value. As discussed above, in some embodiments, the exploration interest value indicates a relative amount that the user explores new content when it is provided. Meanwhile, in some embodiments, the exploration value can fall anywhere within a predefined range, down to a minimum value (e.g., 5%), and up to a maximum value (e.g., 25%). In some embodiments, the exploration calculator 320 converts or otherwise translates the received exploration interest value into a new exploration value.

In one example, the exploration calculator 320 compresses the possible range of the exploration interest value (e.g., 0%-100%) to the predefined range of the exploration value (e.g., 5%-25%). Therefore, a user that always expresses interest in exploration content for a set period of time (e.g., 100%) produces a maximum exploration value of 25%. Likewise, a user that doesn't express any interest in any exploration content for a set time period (e.g., 0%) produces a minimum exploration value of 5%.

In other embodiments, rather than a direct translation between the exploration interest value and the exploration value, the exploration calculator 320 generates a modification to the user's exploration value based on one or more formulas. For example, a high exploration interest value for a set period of time produces an increase to the user's exploration value. In some embodiments, this increase may be proportional to the exploration interest value. For example, a 100% exploration interest value may produce an increase to the user's exploration value of 2%, up to the predefined maximum. Conversely, a 0% exploration interest value may produce a decrease to the user's exploration value of 2%. Values in between 0% and 100% produce relatively changes to the user's exploration value between-2% and 2%, with a 50% interest value producing no change. Every subsequent time period in which the user's behavior is analyzed produces similar changes to the user's exploration value. In different embodiments, the formula can be defined differently, such as with different maximum adjustment increments, different stable points, and/or different exploration value maximums and minimums.

In other embodiments, rather than a predefined adjustment formula, the formal and/or the exploration value can be generated using one or more artificial intelligence (AI) models. The AI models can take inputs, including the exploration interest value received from the behavior processing module 310, the user's current exploration value, and previous adjustment and response data including amounts of adjustments previously made based on past user behavior and the resulting exploration results in subsequent time periods. Using this information, the one or more AI models can modify the parameters of the modification formula used to generate the exploration value adjustment and/or generate an adjusted exploration value directly.

Once the adjusted exploration value has been generated by the exploration calculator 320, the exploration calculator 320 stores the adjusted exploration value as the user's current exploration value in the user database 380. The exploration calculator 320 also provides the user's updated exploration value to the exploration trigger 330.

The exploration trigger 330 determines when exploration content should be provided to the user based on the user's current exploration value. Specifically, as the user browses provided content, the exploration trigger 330 monitors an amount of content being consumed by the user and causes exploration content to be suggested or otherwise provided to the user a percentage of the time equal to the user's exploration value. Thus, for a user with a 10% exploration value, the exploration trigger 330 will cause exploration content to be provided to the user 10% or the time, or may case 10% of content that is provided to the user to be exploration content.

When an exploration content trigger is generated by the exploration trigger 330, this trigger is provided to the content supplier 340. The content supplier 340, upon receiving the exploration trigger, causes exploration content to be provided to the user. The specific content selected as exploration content may be based on a wide variety of factors, including past user behavior, relationship to known content of interest, similarity to content consumed by users with similar interests, etc.

Subsequent user content consumption behavior then causes the above to be repeated.

FIG. 4 illustrates a block diagram of an exemplary exploration calculator 400 according to some embodiments of the present disclosure. As shown in FIG. 4, the exploration calculator 400 includes a proclivity analyzer 420, an exploration retrieval 420, an exploration adjustment model 430, and an exploration output 440, and may represent an exemplary embodiment of exploration calculator 320.

As discussed above, the exploration calculator 400 receives behavior data from the behavior processing module 310. In some embodiments, the behavior data is a score or value indicative of exploration interest of the user. In alternative embodiments, the behavior data includes the user's behavior relative to provided exploration content, including amounts that the user clicks on, ignores, stops at, peruses, or otherwise shows an interest in the provided exploration content for a given period of time.

The exploration calculator 320 receives this data at the proclivity analyzer 410. The proclivity analyzer analyzes the received behavior data to determine the user's proclivity for deviating towards exploration content. When the behavior data includes a score or value demonstrating the user's interest, then the proclivity analyzer may output the received value/score.

However, when behavior data is received indicating the user's actions with respect to exploration content, the proclivity analyzer analyzes the behavioral data in order to generate a proclivity score indicative of the user's likelihood or proclivity for demonstrating interest in exploration content. In some embodiments, the proclivity score may be the same as the exploration interest value described above with respect to the behavior processing module 310. The proclivity analyzer 410 outputs the resultant proclivity value to the exploration adjustment model.

Meanwhile, the exploration retrieval 420 obtains the user's current exploration value from the user database 480. The exploration retrieval 420 outputs the user's current exploration value to the exploration adjustment model 430. In some embodiments, the user's current exploration value indicates an amount, or a score representative of an amount, that the user is currently being provided with exploration content.

The exploration adjustment model 430 receives the proclivity score and the user's current exploration value. The exploration adjustment model 430 then applies various calculations, processes, and/or formulas to the received information in order to determine whether an adjustment to the user's current exploration value is needed. As discussed above, in some embodiments, the proclivity value may indicate a relative amount that the user explores new content when it is provided. Meanwhile, in some embodiments, the user's exploration value can fall anywhere within a predefined range, down to a minimum value (e.g., 5%), and up to a maximum value (e.g., 25%). In some embodiments, the exploration calculator 320 converts or otherwise translates the received exploration interest value into a new exploration value.

In one example embodiment, the exploration adjustment model 430 may perform a conversion of the user's proclivity value to an updated exploration value. This can be done, for example, by compressing the possible range of the proclivity value (e.g., 0%-100%) to the predefined range of the exploration value (e.g., 5%-25%). Therefore, a user that always expresses interest in exploration content for a set period of time (e.g., 100%) produces a maximum exploration value of 25%. Likewise, a user that doesn't express any interest in any exploration content for a set time period (e.g., 0%) produces a minimum exploration value of 5%.

In another example embodiment, rather than a direct translation between the exploration interest value and the exploration value, the exploration adjustment model 430 generates a modification to the user's exploration value based on one or more rules or formulas. For example, a high proclivity value for a set period of time may produce an increase to the user's exploration value. In some embodiments, this increase may be proportional to the exploration interest value. For example, a 100% exploration interest value may produce an increase to the user's exploration value of 2%, up to the predefined maximum. Conversely, a 0% exploration interest value may produce a decrease to the user's exploration value of 2% down to the predefined minimum exploration value. Values in between 0% and 100% produce relative changes to the user's exploration value between −2% and 2%, with a 50% interest (e.g., baseline) value producing no change. Every subsequent time period in which the user's behavior is analyzed produces similar changes to the user's exploration value. In different embodiments, the formula can be defined differently, such as with different maximum adjustment increments, different stable points, and/or different exploration value maximums and minimums.

In another example embodiment, rather than a predefined adjustment formula, the exploration adjustment model can employ one or more artificial intelligence (AI) models to generate the formula and/or the exploration value from the received data. The AI model can take inputs, including the exploration interest value received from the behavior processing module 310, the user's current exploration value, and previous adjustment and response data including amounts of adjustments previously made based on past user behavior and the resulting exploration results in subsequent time periods. Using this information, the one or more AI model can modify the parameters of the modification formula used to generate the exploration value adjustment and/or generate an adjusted exploration value directly.

Once the exploration adjustment model 430 has generated the updated user exploration value, the exploration output 440 provides the user exploration value both to the exploration trigger for content providing, as well as stores the updated user exploration value in the user database 480 for future reference and adjustment calculation.

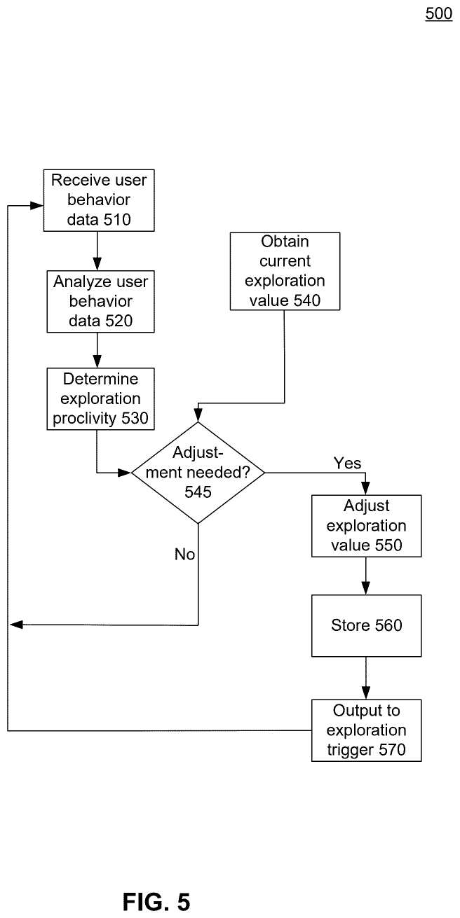

FIG. 5 illustrates a flowchart diagram of an exemplary method 500 for exploration value adjustment, according to some embodiments of the present disclosure. Method 500 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 5, as will be understood by a person of ordinary skill in the art.

Method 500 shall be described with reference to FIG. 4. However, method 500 is not limited to that example embodiment.

The method 500 begins at step 510 where the proclivity analyzer 410 receives behavioral data of the user relating to the user's interactions with exploration content. As discussed above, this behavioral data may include a variety of different interactions, including selecting, ignoring, slowing, stopping, or otherwise expressing an interest in provided exploration content.

In step 520, the proclivity analyzer 410 analyzes the user behavior data. In some embodiments, this can include determine which data points demonstrate the user's interest in exploration content, as well as determining an amount of the exploration content that the user expressed interest in, or a frequency with which the user expresses interest in provided exploration content.

In step 530, the proclivity analyzer 410 determines an exploration proclivity of the user based on the analysis in step 520. In some embodiments, the exploration proclivity can be represented as a value or a score indicative of the user's fondness for and/or likelihood of expressing interest in exploration content. As discussed above, in some embodiments, steps 510-530 may instead be performed by the behavior processing module 310 of FIG. 3.

In step 540, the exploration retrieval 420 obtains the user's current exploration value from the user database 480. In some embodiments, the user's current exploration value is indicative of an amount of exploration content currently being provided to the user when content suggestions are provided to the user.

In step 545, the exploration adjustment model 430 determines whether an adjustment to the user's current exploration value is needed. In some embodiments, this determination is based on an amount that the user current expresses interest in exploration content when that content is provided. For example, if the user's demonstrated interest in exploration content is sufficiently high, it may indicate that too little exploration content is being provided to the user, and that an increase to the user's exploration value is required. Likewise, if the user's demonstrated interest in exploration content is sufficiently low, this may indicate that too much exploration content is being provided to the user, and that a decrease to the user's exploration value is needed. Meanwhile, a user that demonstrates an interest level that is neither too high, nor too low, may suggest that the user's exploration value is well balanced and does not need adjustment.

If, in step 545, it is determined that no adjustment is needed (545—No), then the method 500 returns to step 510 for a subsequent time period to repeat the above analysis. If, on the other hand, it is determined in step 545 that an adjustment is needed (545—Yes), then the method 500 proceeds to step 550.

In step 550, the exploration adjustment model 430 calculates an adjustment to the user's exploration value. In some embodiments, this can be performed based on one or more conversions of the user's proclivity, one or more rules or formulas in order to calculate a new exploration value or an adjustment to the user's current exploration value, and/or can be calculated using one or more AI models trained to identify an optimal exploration value for a particular user based on their exploration habits/interest, etc.

In step 560, the exploration output 440 stores the resulting user exploration value in the user database. In step 570, the exploration output 440 also provides the resulting user exploration value to the exploration trigger, which will provide future content to the user based on the updated exploration value. Following step 570, the method 500 returns to step 510 to repeat the process for a subsequent time period of user behavioral monitoring.

### Example Computer System

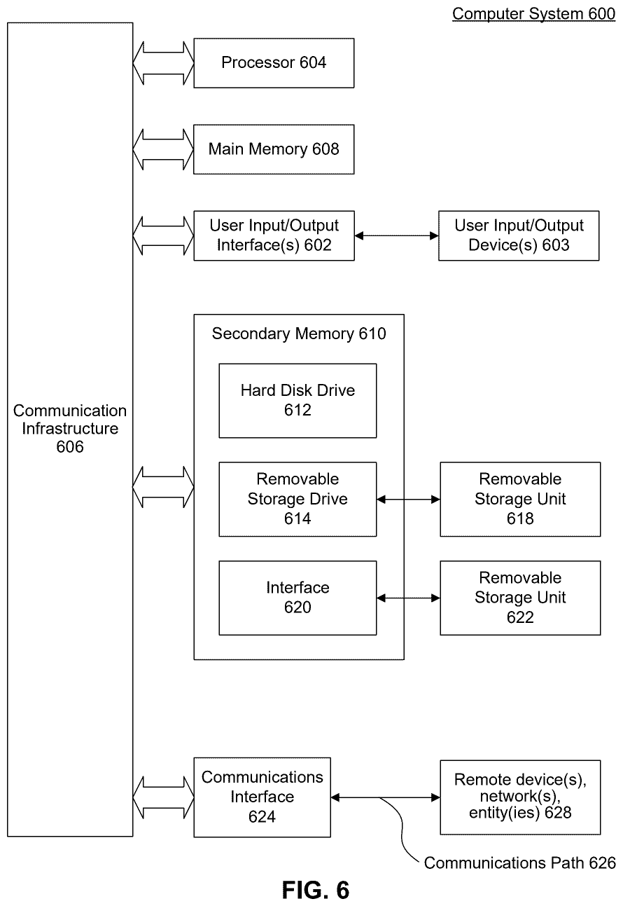

Various embodiments may be implemented, for example, using one or more well-known computer systems, such as computer system 600 shown in FIG. 6. For example, the media device 106 may be implemented using combinations or sub-combinations of computer system 600. Also or alternatively, one or more computer systems 600 may be used, for example, to implement any of the embodiments discussed herein, as well as combinations and sub-combinations thereof.

Computer system 600 may include one or more processors (also called central processing units, or CPUs), such as a processor 604. Processor 604 may be connected to a communication infrastructure or bus 606.

Computer system 600 may also include user input/output device(s) 603, such as monitors, keyboards, pointing devices, etc., which may communicate with communication infrastructure 606 through user input/output interface(s) 602.

One or more of processors 604 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 600 may also include a main or primary memory 608, such as random access memory (RAM). Main memory 608 may include one or more levels of cache. Main memory 608 may have stored therein control logic (i.e., computer software) and/or data.

Computer system 600 may also include one or more secondary storage devices or memory 610. Secondary memory 610 may include, for example, a hard disk drive 612 and/or a removable storage device or drive 614. Removable storage drive 614 may be a floppy disk drive, a magnetic tape drive, a compact disk drive, an optical storage device, tape backup device, and/or any other storage device/drive.

Removable storage drive 614 may interact with a removable storage unit 618. Removable storage unit 618 may include a computer usable or readable storage device having stored thereon computer software (control logic) and/or data. Removable storage unit 618 may be a floppy disk, magnetic tape, compact disk, DVD, optical storage disk, and/any other computer data storage device. Removable storage drive 614 may read from and/or write to removable storage unit 618.

Secondary memory 610 may include other means, devices, components, instrumentalities or other approaches for allowing computer programs and/or other instructions and/or data to be accessed by computer system 600. Such means, devices, components, instrumentalities or other approaches may include, for example, a removable storage unit 622 and an interface 620. Examples of the removable storage unit 622 and the interface 620 may include a program cartridge and cartridge interface (such as that found in video game devices), a removable memory chip (such as an EPROM or PROM) and associated socket, a memory stick and USB or other port, a memory card and associated memory card slot, and/or any other removable storage unit and associated interface.

Computer system 600 may further include a communication or network interface 624. Communication interface 624 may enable computer system 600 to communicate and interact with any combination of external devices, external networks, external entities, etc. (individually and collectively referenced by reference number 628). For example, communication interface 624 may allow computer system 600 to communicate with external or remote devices 628 over communications path 626, which may be wired and/or wireless (or a combination thereof), and which may include any combination of LANs, WANs, the Internet, etc. Control logic and/or data may be transmitted to and from computer system 600 via communication path 626.

Computer system 600 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 600 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 600 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 600, main memory 608, secondary memory 610, and removable storage units 618 and 622, as well as tangible articles of manufacture embodying any combination of the foregoing. Such control logic, when executed by one or more data processing devices (such as computer system 600 or processor(s) 604), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 6. In particular, embodiments can operate with software, hardware, and/or operating system implementations other than those described herein.

### CONCLUSION

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

1. A computer-implemented method for adjusting an amount of exploration content provided during a content consumption session, comprising:
analyzing, by at least one computer processor, behavioral data of a user during Internet browsing or other content-consumption browsing;
determining, based on the analysis, a proclivity for exploration data associated with the user, the exploration data defining an amount of content to be provided to the user that falls outside of a filter bubble associated with the user;
comparing the proclivity to a current exploration value associated with the user;
adjusting the current exploration value based on the comparing to generate an updated exploration value; and
in response to the adjusting, automatically outputting the exploration content to the user consistent with the updated exploration value.

2. The computer-implemented method of claim 1, wherein the behavioral data of the user relates to interaction of the user with the exploration content.

3. The computer-implemented method of claim 2, wherein the behavioral data of the user includes selections, clicks, and pauses with respect to the exploration content.

4. The computer-implemented method of claim 1, wherein the proclivity is determined based on a frequency with which the user interacts with, or otherwise expresses interest in, the exploration content.

5. The computer-implemented method of claim 1, wherein the adjusting the current exploration value comprises:
converting the proclivity, based on a range of the proclivity, to a corresponding suggested exploration value within a range of exploration values; and
setting the updated exploration value equal to the suggested exploration value.

6. The computer-implemented method of claim 1, wherein the adjusting the current exploration value comprises:
comparing the proclivity to a predefined proclivity baseline value;
determining a difference between the proclivity and the predefined proclivity baseline value;
calculating an adjustment value within an adjustment range based on the difference; and
calculating the updated exploration value based on the current exploration value adjusted by the adjustment value.

7. The computer-implemented method of claim 1, wherein the adjusting the current exploration value comprises:
providing the behavioral data of the user, the current exploration value, and historical adjustment data to an artificial intelligence (AI), machine-learning model; and
receiving the updated exploration value from the AI machine-learning model.

8. A system for adjusting an amount of exploration content provided during a content consumption session, comprising:
one or more memories; and
at least one processor each coupled to at least one of the memories and configured to perform operations comprising:
analyzing behavioral data of a user during Internet browsing or other content-consumption browsing;
determining, based on the analysis, a proclivity for exploration data associated with the user, the exploration data defining an amount of content to be provided to the user that falls outside of a filter bubble associated with the user;
comparing the proclivity to a current exploration value associated with the user;
adjusting the current exploration value based on the comparing to generate an updated exploration value; and
outputting the exploration content to the user consistent with the updated exploration value.

9. The system of claim 8, wherein the behavioral data of the user relates to interaction of the user with the exploration content.

10. The system of claim 9, wherein the behavioral data of the user includes selections, clicks, and pauses with respect to the exploration content.

11. The system of claim 8, wherein the proclivity is determined based on a frequency with which the user interacts with, or otherwise expresses interest in, the exploration content.

12. The system of claim 8, wherein the adjusting the current exploration value comprises:
converting the proclivity, based on a range of the proclivity, to a corresponding suggested exploration value within a range of exploration values; and
setting the updated exploration value equal to the suggested exploration value.

13. The system of claim 8, wherein the adjusting the current exploration value comprises:
comparing the proclivity to a predefined proclivity baseline value;
determining a difference between the proclivity and the predefined proclivity baseline value;
calculating an adjustment value within an adjustment range based on the difference; and
calculating the updated exploration value based on the current exploration value adjusted by the adjustment value.

14. The system of claim 8, wherein the adjusting the current exploration value comprises:
providing the behavioral data of the user, the current exploration value, and historical adjustment data to an artificial intelligence (AI), machine-learning model; and
receiving the updated exploration value from the AI machine-learning model.

15. A non-transitory computer-readable medium having instructions stored thereon that, when executed by at least one computing device, cause the at least one computing device to perform operations comprising:
analyzing behavioral data of a user during Internet or other content-consumption browsing;
determining, based on the analysis, a proclivity for exploration data associated with the user, the exploration data defining an amount of content to be provided to the user that falls outside of a filter bubble associated with the user;
comparing the proclivity to a current exploration value associated with the user;
adjusting the current exploration value based on the comparing to generate an updated exploration value; and
outputting exploration content to the user consistent with the updated exploration value.

16. The non-transitory computer-readable medium of claim 15, wherein the behavioral data of the user relates to interaction of the user with the exploration content, and
wherein the behavioral data of the user includes selections, clicks, and pauses with respect to the exploration content.

17. The non-transitory computer-readable medium of claim 15, wherein the proclivity is determined based on a frequency with which the user interacts with, or otherwise expresses interest in, the exploration content.

18. The non-transitory computer-readable medium of claim 15, wherein the adjusting the current exploration value comprises:
converting the proclivity, based on a range of the proclivity, to a corresponding suggested exploration value within a range of exploration values; and
setting the updated exploration value equal to the suggested exploration value.

19. The non-transitory computer-readable medium of claim 15, wherein the adjusting the current exploration value comprises:
comparing the proclivity to a predefined proclivity baseline value;
determining a difference between the proclivity and the predefined proclivity baseline value;
calculating an adjustment value within an adjustment range based on the difference; and
calculating the updated exploration value based on the current exploration value adjusted by the adjustment value.

20. The non-transitory computer-readable medium of claim 15, wherein the adjusting the current exploration value comprises:
providing the behavioral data of the user, the current exploration value, and historical adjustment data to an artificial intelligence (AI), machine-learning model; and
receiving the updated exploration value from the AI machine-learning model.
